(19) United States
(12) Patent Application Publication
(10) Pub. No.: US 2023/0350367 A1
(43) Pub. Date: Nov. 2, 2023

(54) POWER MANAGEMENT DEVICE AND POWER MANAGEMENT SYSTEM

(71) Applicant: TOYOTA JIDOSHA KABUSHIKI KAISHA, Toyota-shi (JP)

(72) Inventors: Mitsuaki TOMITA, Toyota-shi (JP); Makito MURAMATSU, Toyota-shi (JP); Miyako SAKAI, Toyota-shi (JP); Maiko HAYASHI, Toyota-shi (JP); Hirohiko TANIGUCHI, Yokohama-shi (JP)

(73) Assignee: TOYOTA JIDOSHA KABUSHIKI KAISHA, Toyota-shi (JP)

(21) Appl. No.: 18/121,842

(22) Filed: Mar. 15, 2023

(30) Foreign Application Priority Data
May 2, 2022 (JP) 2022-076092

(51) Int. Cl. G05B 19/042

(52) U.S. Cl. CPC G05B 19/042; G05B 2219/2639

(57) ABSTRACT

The server (power management device) is a power management device that acquires information on a power state of an accommodation facility. The server includes a communication unit (acquiring unit) for acquiring the information, and a processor (control unit) for requesting a user of the electrified vehicle to perform power control on EVSE using the electrified vehicle based on the information acquired by the communication unit. Then, when a predetermined condition related to power control is satisfied by the user, the processor gives a privilege related to the accommodation facility to the user.

### CROSS-REFERENCE TO RELATED APPLICATION

This application claims priority to Japanese Patent Application No. 2022-076092 filed on May 2, 2022, incorporated herein by reference in its entirety.

### BACKGROUND

### 1. Technical Field

The present disclosure relates to a power management device and a power management system.

### 2. Description of Related Art

Japanese Unexamined Patent Application Publication No. 2020-047018 (JP 2020-047018 A) discloses an accommodation facility management system including a power usage mode recognition unit that recognizes a power usage mode by a user of an accommodation facility. Further, the accommodation facility management system includes an electricity use plan selection unit that selects an electricity use plan of the accommodation facility during a use period of the accommodation facility by the user, based on the electricity use mode recognized by the electricity use mode recognition unit.

### SUMMARY

However, in JP 2020-047018 A, only the electricity use plan of the accommodation facility is selected based on the mode of electricity use by the user, and the user is less likely to clearly feel the advantage in using the accommodation facility. Thus, it is considered difficult to promote the use of the accommodation. Therefore, it is desired to increase the number of users of accommodation facility by promoting the use of accommodation facility.

The present disclosure provides a power management device and a power management system capable of increasing the number of users of an accommodation facility by promoting the use of the accommodation facility.

A power management device according to a first aspect of the present disclosure is a power management device that acquires information of a power state of at least one of an accommodation facility and a region in which the accommodation facility is provided, and includes: an acquiring unit that acquires information; and a control unit that requests a user of an electrified vehicle to perform power control in a power stand based on the information acquired by the acquiring unit, the power control including at least one of external charging and external power supply by using the electrified vehicle, in which the control unit gives a benefit related to the accommodation facility to the user when a predetermined condition related to the power control is satisfied by the user.

In the power management device according to the first aspect of the present disclosure, as described above, the benefit related to the accommodation facility is given to the user when the predetermined condition related to power control is satisfied by the user. Thus, the user who has obtained the benefit related to the accommodation facility more frequently uses the accommodation facility, thereby promoting the use of the accommodation facility. As a result, the number of users of the accommodation facility can be increased. In addition, since the power control by the user for the benefit is promoted, the power state of at least one of the accommodation facility and the region where the accommodation facility is provided can be easily adjusted by the power control of the electrified vehicle.

Further, in the power management device according to the first aspect, the control unit may give a benefit to the user, when the predetermined condition is satisfied by the user, in the power stand provided in the accommodation facility. With this configuration, since more users visit the accommodation facility (power stand) in order to perform the power control, the number of users of the accommodation facility can be further increased.

Further, in the power management device according to claim 1 or 2, the control unit may give the benefit to the user in at least one of a case in which power is supplied to the accommodation facility by the external power supply and a case in which the power control is performed in response to a power supply and demand adjustment request from a power system in the region. According to this configuration, the power is supplied to the accommodation facility by external power supply and thus, it is possible to suppress a power shortage of the accommodation facility. Further, by performing the power control for the power supply and demand adjustment request from the power system in the region, it is possible to easily move (peak shift) and decrease (peak cut) the peak of the power used in the accommodation facility provided in the region. As a result, the accommodation facility can obtain a profit, and thus the benefit can be easily given to the user by returning the profit to the user.

In the power management device according to the first aspect, the control unit may adjust the benefit in accordance with the contribution degree of the user in the power control. With such a configuration, the user who is focused on obtaining more benefits more actively performs the power control and thus, it is possible to further promote the power control.

Further, in the power management device according to the first aspect, giving the benefit may include at least one of the following: reducing a usage fee of the accommodation facility; giving at least one of a coupon and a point that is able to be used in at least one of the accommodation facility and a store near the accommodation facility; and providing a predetermined service in the accommodation facility at less than a normal fee corresponding to the predetermined service. With such a configuration, the user can easily feel a clear advantage in using the accommodation facility. Accordingly, it is possible to further promote the usage of the accommodation facility.

In the power management device according to the first aspect, the predetermined condition may include that the electrified vehicle is electrically connected to the power stand. With this configuration, it is possible to suppress the user from obtaining the benefit without performing the power control. As a result, it is possible to suppress a benefit from being acquired by a malicious user.

A power management system according to a second aspect of the present disclosure is a power management device that acquires information of a power state of at least one of an accommodation facility and a region in which the accommodation facility is provided, and includes: an acquiring unit that acquires information; and a control unit that requests a user of an electrified vehicle to perform power control in a power stand, the power control including at least one of external charging and external power supply by using the electrified vehicle, based on the information acquired by the acquiring unit, in which the control unit gives a benefit related to the accommodation facility to the user when a predetermined condition related to the power control is satisfied by the user.

In the power management system according to the second aspect of the present disclosure, as described above, the benefit related to the accommodation facility is given to the user when the predetermined condition related to power control is satisfied by the user. Thus, the user who has obtained the benefit related to the accommodation facility more frequently uses the accommodation facility, thereby promoting the use of the accommodation facility. As a result, it is possible to provide a power management system capable of increasing the number of users of an accommodation facility.

According to the present disclosure, it is possible to increase the number of users of an accommodation facility by promoting the use of the accommodation facility.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a power management system according to a first embodiment;

FIG. 2 is a sequence diagram illustrating sequence control of the power management stem according to the first embodiment;

FIG. 3 is a diagram illustrating an example of a privilege selection screen;

FIG. 4 is a diagram illustrating an example of a list of selectable privileges;

FIG. 5 is a diagram illustrating a schematic configuration of a power management system according to a second embodiment:

FIG. 6 is a sequence diagram illustrating sequence control by the power management stem according to the second embodiment.

### DETAILED DESCRIPTION OF EMBODIMENTS

### First Embodiment

Hereinafter, a first embodiment of the present disclosure will be described in detail with reference to the drawings. In the drawings, the same or corresponding parts are denoted by the same reference signs and the description thereof will not be repeated.

### Configuring the Power Management System

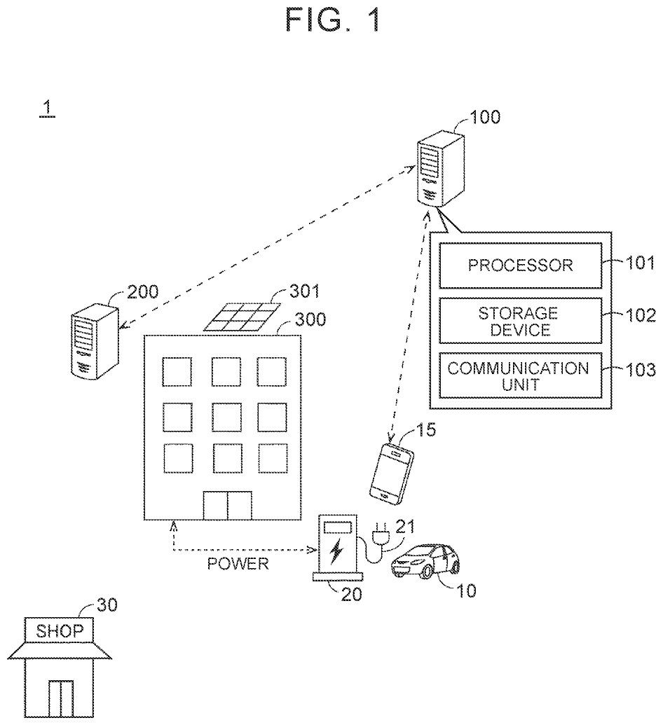

FIG. 1 is a diagram illustrating a configuration of a power management system 1 according to a first embodiment. The power management system 1 includes a server 100, a server 200, electrified vehicles 10, and an Electric Vehicle Supply Equipment (EVSE) 20. Note that the servers 100 and EVSE 20 are exemplary “power management device” and “power stands” of the present disclosure, respectively.

The server 100 includes a processor 101, a storage device 102, and a communication unit 103. Note that the processor 101 and the communication unit 103 are examples of the “control unit” and the “acquiring unit” of the present disclosure, respectively.

The storage device 102 stores a program to be executed by the processor 101 and information (for example, a map, a mathematical expression, and various parameters) used in the program. The communication unit 103 includes various communication I/F. The processor 101 controls the communication unit 103. Specifically, the processor 101 communicates with the server 200 through the communication unit 103. The processor 101 communicates with a mobile terminal 15 (for example, a smartphone or a tablet) that can be carried by a user through the communication unit 103.

Further, the servers 100 are configured to manage information (hereinafter, also referred to as “vehicle information”) of the plurality of registered electrified vehicles 10, information (hereinafter, also referred to as “user information”) of the respective registered users, and information (hereinafter, also referred to as “EVSE information”) of the registered EVSE 20. The user information, the vehicle information, and EVSE information are stored in the storage device 102 distinguished by the identification information (ID).

The user ID is identification information for identifying the user, and also functions as information (terminal ID) for identifying the mobile terminal 15 carried by the user. The servers 100 are configured to store information received from the mobile terminals 15 separately for each user ID. The user data includes a communication address of the mobile terminal 15 carried by the user and a vehicle ID of the electrified vehicle 10 belonging to the user.

The vehicle ID is identification information for identifying the electrified vehicle 10. The vehicle ID may be a license plate or may be a Vehicle Identification Number (VIN). The vehicle information includes an action schedule of each electrified vehicle 10.

EVSE-ID is identification information for identifying EVSE 20. EVSE data includes the communication addresses of the respective EVSE 20 and the status of the electrified vehicles 10 connected to the respective EVSE 20. EVSE information also includes information (for example, a combination of an EVSE-ID and a vehicle ID) indicating a combination of the electrified vehicle 10 and EVSE 20 connected to each other.

The server 200 is a server that manages the power state of the accommodation facility 300. The accommodation facility 300 includes a hotel, a hot spring inn, and the like. The accommodation facility 300 includes a photovoltaic power generation facility 301 capable of generating electric power by sunlight. The accommodation facilities 300 are integrally monitored and automatically controlled by Building Energy Management System (BEMS).

In addition, the accommodation facility 300 is provided with an EVSE 20. EVSE 20 is provided, for example, in a parking lot of the accommodation facility 300. The number of EVSE 20 may be one or a plurality.

EVSE 20 means a vehicular power supply facility. The electrified vehicles 10 are configured to be electrically connectable to an EVSE 20. For example, the charge cable 21 connected to EVSE 20 is connected to an inlet (not shown) of the electrified vehicle 10, so that electric power can be exchanged between EVSE 20 and the electrified vehicle 10.

The electrified vehicles 10 can exchange electric power with the accommodation facilities 300 via EVSE 20. The electrified vehicle 10 is configured to be capable of control (hereinafter referred to as power control) including external power supply and external charging. Note that the electrified vehicle 10 may be configured to be capable of only one of external power supply and external charging.

Further, the electrified vehicles 10 may include a Data Communication Module (DCM or a communication I/F compatible with a 5G (fifth-generation mobile communication system).

The server 100 acquires information on the power state of the accommodation facility 300. Specifically, the server 100 (the communication unit 103) acquires the information from the server 200 by communication.

The server 100 (the processor 101) requests the user of the electrified vehicle 10 to perform the power control in EVSE 20 based on the information on the power status of the accommodation facility 300 acquired by the communication unit 103. Specifically, the processor 101 requests the user to perform power control at EVSE 20 of the accommodation facility 300.

For example, the processor 101 may request the user to provide power to the accommodation facility 300 by providing external power when the accommodation facility 300 is running out of power. Note that the electric power state of the accommodation facility 300 includes not only the electric power state of the accommodation facility 300 at the present time, but also the estimated electric power state of the accommodation facility 300 in consideration of the estimated amount of electric power generation by the photovoltaic power generation facility 301, for example.

In this case, the processor 101 transmits the request to the mobile terminal 15 of the user through the communication unit 103. The request may be transmitted to the electrified vehicle 10.

Here, in the power management system 1 having the above-described configuration, it is desired to increase the number of users of the accommodation facility 300 by promoting the use of the accommodation facility 300.

Therefore, the processor 101 gives the user a privilege related to the accommodation facility 300 when a predetermined condition related to power control is satisfied by the user.

The user to which the request is transmitted includes, for example, a user who has a track record of using the accommodation facility 300 in the past. In addition, the user to whom the request is transmitted may include a user who is located within a predetermined distance from the accommodation facility 300. Further, the processor 101 may display the request on a screen of the application or the like while the user is making a reservation for use of the accommodation facility 300 by the application or the like. In addition, the user to whom the request is transmitted may include a user who is staying at the accommodation facility 300 and a user who has made a reservation for use of the accommodation facility 300. The processor 101 may transmit the request to all users managed by the server 100.

Further, the processor 101 may select a user (the electrified vehicle 10) who transmits the above-mentioned request based on State Of Charge (SOC of the electrified vehicle 10. For example, if there is a shortage of power in the accommodation facility 300, the processor 101 may send the request to a user of the electrified vehicle 10 having a higher SOC. Also, if there is a surplus in the power of the accommodation facility 300, the processor 101 may transmit the above-described requirement to a user of the electrified vehicle 10 having a lower SOC.

Further, the predetermined condition includes that the electrified vehicles 10 are electrically connected to EVSE 20. Specifically, the processor 101 gives a privilege to the user based on the fact that the electrified vehicles 10 of the user who responded to the request to accept the request are electrically connected to EVSE 20 of the accommodation facility 300. That is, the user cannot receive the privilege unless the electrified vehicles 10 are electrically connected to EVSE 20 while responding to the above requirements. Further, even if the electrified vehicles 10 are electrically connected to EVSE 20 without responding to the above-mentioned requirement, the user cannot receive the above-mentioned privilege.

Note that a privilege may be given to a user on condition that power control is performed for a predetermined time or more (for example, 15 minutes or more) (or that a setting for performing power control for a predetermined time or more is performed by the user). In addition, when the electrified vehicles 10 are electrically connected to EVSE 20, a privilege may be given to the user even if the user does not respond to the above-mentioned requirement.

Further, when the user responds to the above-mentioned requirement, a privilege may be given to the user prior to the electrified vehicles 10 being electrically connected to EVSE 20. In this case, the award may be activated based on the fact that the electrified vehicles 10 are electrically connected to EVSE 20.

Note that a user who is granted a privilege and does not perform power control may be penalized in the next power control in EVSE 20 of the accommodation facility 300 or in EVSE of another facility. Specifically, even if the user performs power control, a predetermined reward (such as the above-described reward or monetary reward) may not be given to the user.

In addition, in the first embodiment, the processor 101 adjusts the privilege according to the contribution of the user in the power control. In other words, the processor 101 adjusts the privilege according to the degree of the user's contribution to the user's request for power control. For example, the processor 101 adjusts the privilege according to the power supply amount (the degree of contribution to the power shortage elimination) by the power control when the user is requested to supply external power due to the power shortage of the accommodation facility 300. In this case, the benefit may be adjusted by not only the power supply amount but also other factors (for example, the power supply start time and the power supply time).

Further, the above-described benefit may be adjusted by a degree other than the contribution in the power control. For example, the benefit may be adjusted based on the current or past power usage in the user's accommodation facility 300 (accommodation room, use room).

The granting of the privilege includes, for example, reducing a usage fee of the accommodation facility 300. The usage fee of the accommodation facility 300 includes an accommodation fee, a usage fee of a restaurant and equipment (a gym, an entertainment room, or the like) in the accommodation facility 300, and the like. Further, the usage fee may include a fee required for early check-in to the accommodation facility 300 and a fee required for layout check-out from the accommodation facility 300.

Granting the privilege also includes granting a coupon and points available at the accommodation facility 300 and the store 30. The above-mentioned coupons and points are given in an application usable in the mobile terminal 15 or the like. Note that the above-described coupon may be given to the user directly (not through communication but by hand).

The store 30 illustrated in FIG. 1 is, for example, a store in the vicinity of the accommodation facility 300. The store 30 includes, for example, a store capable of renting a bicycle. A user who satisfies the predetermined condition in the power control (a user of the accommodation facility 300) is given a coupon or a point at which a bicycle can be rented at a lower price than usual in the store 30.

Further, a user who performs power control during daytime may be awarded an additional benefit (or more valuable than the above benefit).

Note that, since it is considered that sales in the store 30 are increased by giving a preferential ticket or a point available in the store 30 to the user, a commission (margin) of a predetermined amount may be paid from the store 30 to the accommodation facility 300.

Further, providing the privilege includes providing a predetermined service in the accommodation facility 300 at a rate less than a normal fee corresponding to the predetermined service. For example, a given service includes a service that provides beverages (such as black tea and alcohol) free of charge.

In the above description, an example in which power is supplied from the electrified vehicle 10 to the accommodation facility 300 has been described, but the present disclosure is not limited thereto. When there is an excess power in the accommodation facility 300, the user may be required to use the power of the accommodation facility 300 for charging the electrified vehicle 10 by performing external charging. In this case, the privilege may be adjusted on the basis of the amount of charge by external charging of the electrified vehicle 10, the charging start time, the charging time, and the like (the degree of contribution to power surplus elimination).

When the external charge is required as described above, a privilege corresponding to the electrified vehicle 10 being connected to EVSE 20 in a time zone earlier than the normal check-in time (for example, 12 o'clock) may be given to the user. In this case, a privilege is given to external charging performed by the electrified vehicle 10 in a time period in which the amount of power generated by the photovoltaic power generation facility 301 is relatively large (contribution to power surplus elimination).

Further, in a case where it is required to perform external charging, a privilege corresponding to the user of the electrified vehicle 10 using the accommodation room for work or the like in a time zone (for example, from 11:00 to 15:00) earlier than the normal check-in time may be given.

In these cases, the privilege may include, for example, a gym of the accommodation facility 300 and a bathroom ticket.

Further, at least one of the above-described various privileges may be selectable by the user. A specific description of this control will be given later.

### Power Management Method

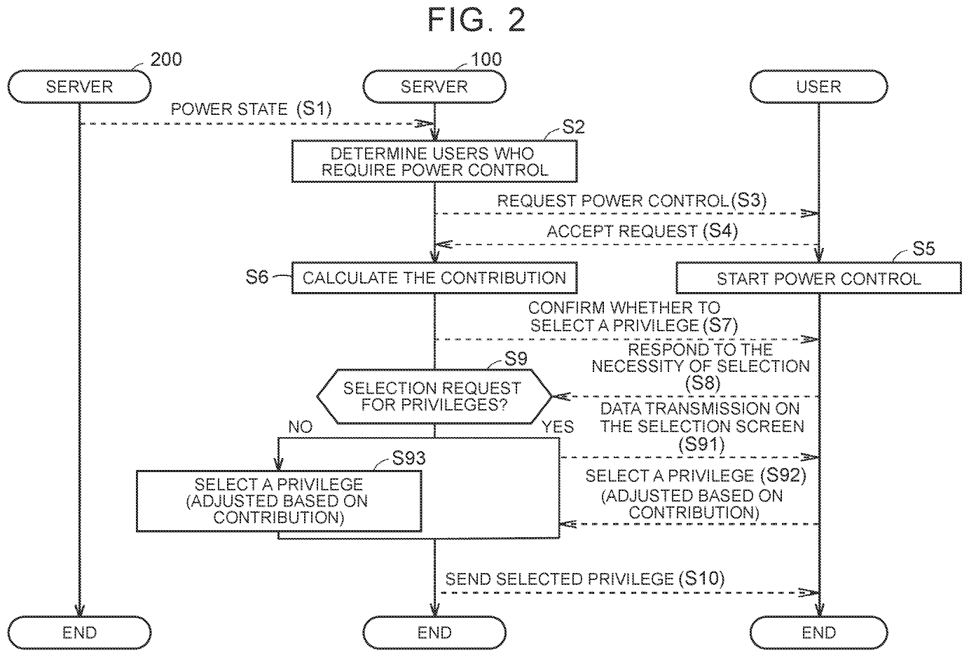

Next, with reference to the sequence diagram of FIG. 2, an example of the sequence control by the power management system 1 until a privilege is given to a user will be described.

First, in the step-wise S1, the server 100 (the communication unit 103) receives information about the power status of the accommodation facility 300 from the server 200.

Next, in the step-wise S2, the processor 101 determines a user (the electrified vehicle 10) to be requested to perform power control. Specific examples of the selection criteria are as described above. It should be noted that the steps S2 may not be provided when the requesting is transmitted to all the users managed by the servers 100.

Next, in step S3, the processor 101 requests the user selected in the step S2 to perform power control (e.g., external power supply) at EVSE 20 of the accommodation facility 300 based on the information received in the step S1. Note that the server 100 may directly transmit an inquiry signal for requesting power control to the electrified vehicle 10 or may transmit the inquiry signal to the mobile terminal 15 of the user.

Next, in the step S4, it is assumed that the user transmits, to the server 100, a signal indicating that the user accepts the request for power control in the step S3 (that the user participates in power control).

Next, in the step S5, it is assumed that the electrified vehicles 10 are electrically connected to EVSE 20, and thus the power control corresponding to the power control requirement in the step S3 is started.

Next, in a stepping S6, the processor 101 calculates the user's contribution in power control. For example, the processor 101 calculates the aforementioned contributions based on the content committed between the electrified vehicle 10 and the server 100 in the step S3 and S4 (charging/charging time, charging/charging amount, charging/charging start time). Further, the contribution degree may be calculated on the basis of the integrated value of the power control by the user (the number of times of the power control so far, the integrated value of the charge (power supply) amount so far, and the like). Note that the degree of contribution in the step S6 may be calculated between the step S4 and the step S5. In addition, the contribution degree in the step S6 may be calculated based on the actual charge (power supply) quantity after the power control is completed. In this case, the information on the charge (power supply) amount is transmitted from the server 200 to the server 100.

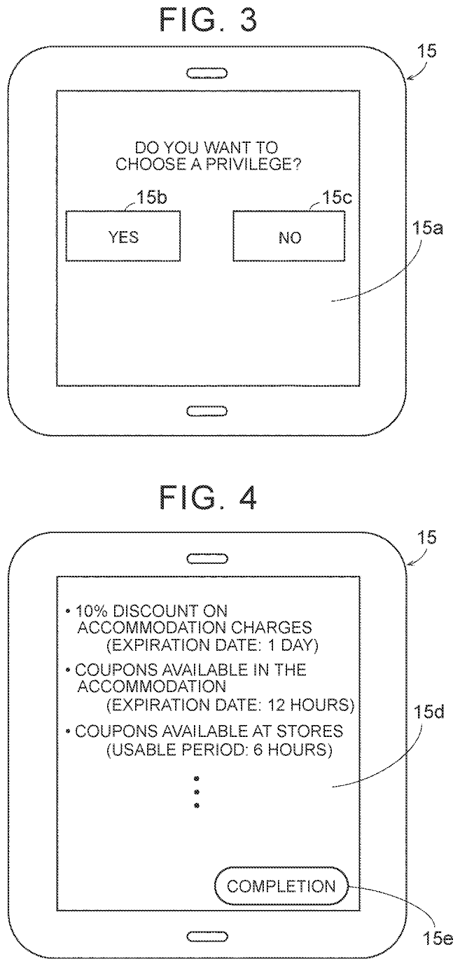

Next, in the step-wise S7, the processor 101 confirms with the user whether to select a privilege to be used. For example, the server 100 (the processor 101) controls the communication unit 103 so that a message screen 15a (see FIG. 3) for confirming whether or not to select a privilege is displayed on the mobile terminal 15 of the user. On the message screen 15a, a button 15b described as “YES” and a button 15c described as “NO” are displayed. When the button 15b described as “YES” is selected, information indicating that a privilege is requested to be selected is transmitted to the server 100. When the button 15c described as “NO” is selected, information indicating that the selection of the privilege is not requested is transmitted to the server 100. Further, the process of the step S7 may be performed prior to the process of the step S6.

Next, in the step S8, it is assumed that the user has responded to the confirmation in the step S7. That is, it is assumed that one of the button 15b described as “YES” and the button 15c described as “NO” in the message screen 15a is selected.

Next, in a S9 of steps, the processor 101 determines whether or not a user requests to select a privilege. If the user requests to select a privilege in the step S8 (i.e., if a button 15b labeled “YES” is selected), the processor 101 determines that there is a selection request, and the process proceeds to step S91 (Yes in S9). If the user does not request to select a privilege in the step S8 (that is, if the button 15c described as “NO” is selected), the processor 101 determines that there is no selection request, and the process proceeds to the step S93 (No in S9).

In the step S91, the processor 101 controls the communication unit 103 so that the data of the privilege selection screen 15d (see FIG. 4) is transmitted to the mobile terminal 15 of the user. As a result, the selection screen 15d is displayed on the mobile terminal 15. At this time, the type (number) of the privilege selectable in the selection screen 15d, the available period, and the like are adjusted (limited) based on the degree of contribution calculated in S6 of steps.

Next, in the step-wise S92, the user selects at least one of the plurality of privileges displayed on the selection screen 15d. For example, when at least one of the privileges displayed on the selection screen 15d is selected and the button 15e (see FIG. 4) described as “completed” in the selection screen 15d is selected, the information of the privilege selected by the user is transmitted to the servers 100.

On the other hand, in the stepping S93, the processor 101 randomly selects at least one of the plurality of privileges prepared in advance. At this time, the processor 101 adjusts the type (number) of the privilege to be selected, the available period, and the like based on the contribution level. The processor 101 may select a privilege by referring to a history of use of a user's past privilege or the like.

Then, in the step S10, the processor 101 transmits, through the communication unit 103, the privilege selected in the step S92 or the step S93 (the preferential ticket, the point, and the like) to the mobile terminal 15 of the user.

Note that the power management method by the power management system 1 is an example, and the present disclosure is not limited to the above example. For example, it is not necessary to select a privilege or adjust a privilege based on the contribution.

As described above, in the first embodiment, the processor 101 grants a benefit to the user when the predetermined condition related to the power control is satisfied by the user and when the user uses the accommodation facility 300. This makes it possible to increase the number of users of the electrified vehicle 10 who use the accommodation facility 300 in view of the privilege. Further, it is possible to easily suppress the deterioration of the power state of the accommodation facility 300 by using the electric power of the electrified vehicle 10.

### Second Embodiment

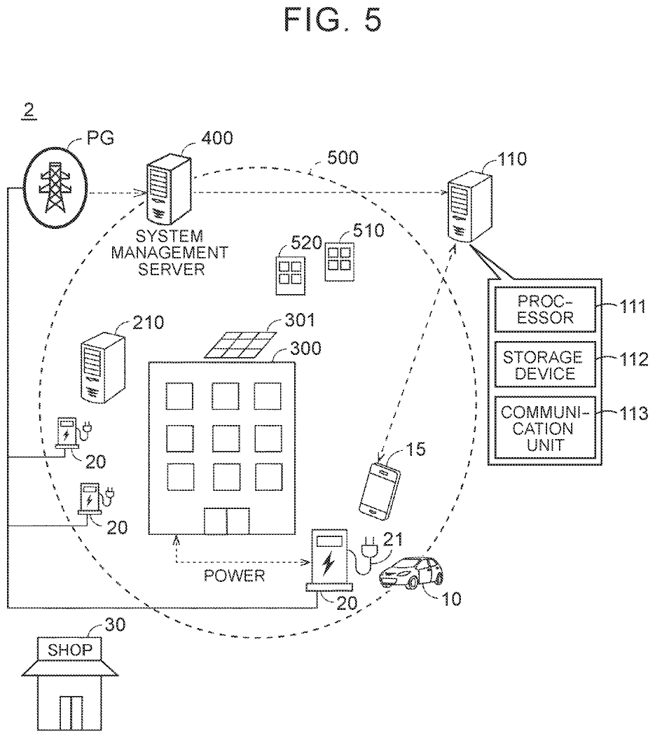

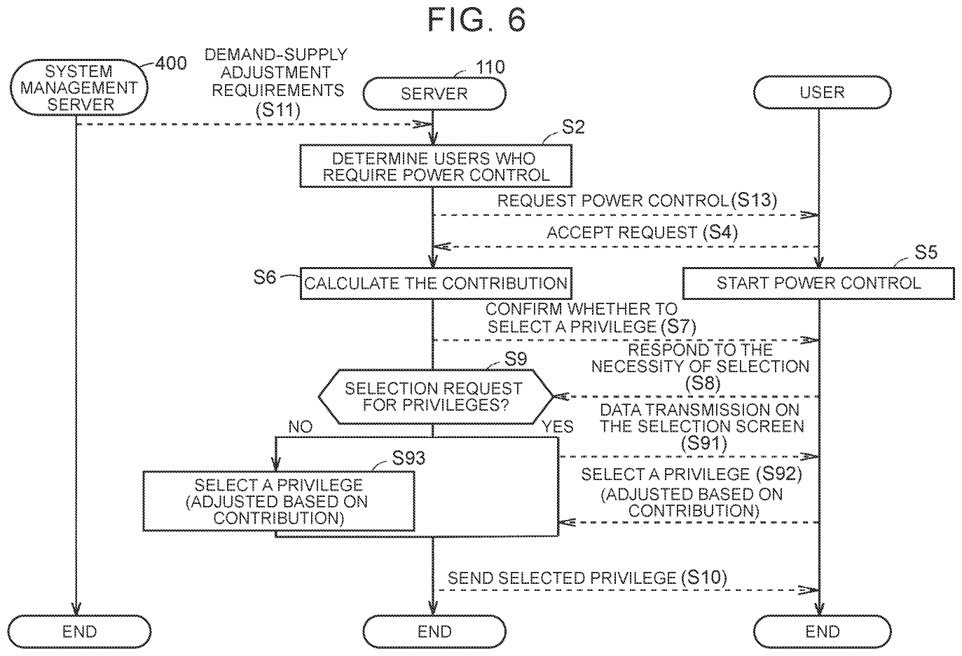

Next, the server 110 and the power management system 2 according to the second embodiment will be described with reference to FIG. 5 and FIG. 6.

### Configuring the Power Management System

FIG. 5 is a diagram illustrating a configuration of the power management system 2 according to the second embodiment. The power management system 2 includes a server 110, a server 210, a system management server 400, electrified vehicles 10, an EVSE 20, and a power system PG. The power management system 2 is a system that manages the power supply and demand status of the power system PG for the respective power adjustment resources (the accommodation facility 300, the electrified vehicles 10, the buildings 510, the buildings 520, and the like) in the region 500. In the embodiment illustrated in FIG. 5, a plurality of EVSE 20 is provided in a region 500 to be described later. Note that the server 110 is an example of a “power management device” of the present disclosure.

The server 110 includes a processor 111, a storage device 112, and a communication unit 113. Note that the processor 111 and the communication unit 113 are examples of the “control unit” and the “acquiring unit” of the present disclosure, respectively.

The server 210 is a server that manages the power state of the accommodation facility 300. Each of the plurality of EVSE 20 is electrically connected to the power system PG. Therefore, the plurality of EVSE 20 is electrically connected to each other via the power grid of the power system PG. Although the power system PG is not illustrated in FIG. 1 of the first embodiment, the power system PG and EVSE 20 are electrically connected to each other in the same manner as in the second embodiment.

The power system PG is a power grid constructed by a power plant and a transmission and distribution facility (not shown). In the second embodiment, the electric power company also serves as a power generation company and a power transmission and distribution company. The electric power companies correspond to ordinary transmission and distribution companies, and maintain and manage the power system PG. The electric power companies correspond to administrators of the power system PG.

The system management servers 400 manage the supply and demand of the power system PG (power grid). The system management server 400 belongs to an electric power company. The system management server 400 transmits a request (supply-demand adjustment request) for adjusting the power demand of the power system PG to the server 110 (the communication unit 113) based on the power generation and consumption of the electric power by the respective power adjustment resources in the region 500. Specifically, the system management server 400 transmits, to the server 110, a request for increasing or decreasing the power demand amount compared to the normal time when the generated power or the power consumption of the power adjustment resource is expected to be larger than the normal time (or when the generated power or the power consumption is currently larger). Note that the supply-and-demand adjustment request is an example of the “information on the power state of the region” and the “power supply-and-demand adjustment request from the power system” of the present disclosure.

The processor 111 requests the user of the electrified vehicle 10 to perform the power control in EVSE 20 based on the supply-and-demand adjusting request acquired by the communication unit 113. For example, if the processor 111 receives a request to increase the power demand compared to the normal time, it requests the user to perform an external charge in EVSE 20. In addition, when the processor 111 receives a request for reducing the power demand than in the normal state, it requests the user to perform external power supply in EVSE 20.

Here, in the second embodiment, the processor 111 gives a privilege related to the accommodation facility 300 to the user when the power control is performed on the supply-demand adjustment request (a predetermined condition related to the power control is satisfied). Note that, in the second embodiment, not only EVSE 20 of the accommodation facilities 300 but also a privilege is given to the user when power control is performed using any EVSE 20 in the region 500.

Further, in the example illustrated in FIG. 5, since only the accommodation facility 300 exists in the region 500, a privilege (available in the accommodation facility 300 and the store 30) related to the accommodation facility 300 is given to the user. On the other hand, when there is a plurality of accommodations in the region 500, a privilege that can be used in any of the plurality of accommodations (and a store in the vicinity of each accommodation) may be given to the user.

Further, in the second embodiment, the processor 111 adjusts the privilege to be given to the user based on the degree of contribution to the demand/supply adjustment request from the power system PG (system management server 400).

Note that the peak of the power used by the accommodation facility 300 is easily moved (peak shift) and lowered (peak cut) by the power control by the user. Based on this achievement, the contract cost between the accommodation facility 300 and the electric power company is reduced, and the cost that can be spent on the privilege is increased.

### Electric Control Method

Next, an example of a power management method by the server 110 will be described with reference to the sequence diagram of FIG. 6. The same contents as those of the first embodiment will not be described repeatedly.

First, in the step-wise S11, the communication unit 113 receives a demand/supply adjustment request from the system management server 400.

In step S13, the processor 111 requests the user selected in the step S2 to perform power control in EVSE 20 in the region 500 based on the information received in the step S11. It should be noted that the processor 111 may require power control to be performed at a particular EVSE 20 (e.g., EVSE 20 of the accommodation facility 300).

As described above, in the second embodiment, the processor 111 gives a benefit to the user when a predetermined condition related to power control is satisfied by the user and when the user uses the accommodation facility 300. As a result, as in the first embodiment, it is possible to increase the number of users of the electrified vehicle 10 using the accommodation facility 300 with a view to a privilege. Further, by promoting the power control by the electrified vehicles 10, it is possible to improve the power supply-demand balance of the power system PG by the respective power adjusting resources of the region 500.

Note that other configurations and effects are the same as those of the first embodiment, and thus detailed description thereof will not be repeated.

Further, in the first embodiment, the privilege is given when the power control is performed in EVSE 20 of the accommodation facility 300, but the present disclosure is not limited thereto. The power control may be performed in any EVSE as long as EVSE exists in the power grid shared with EVSE 20 of the accommodation facility 300.

Further, in the first and second embodiments, an example has been described in which a privilege is given to a user who satisfies a predetermined condition with respect to power control, but the present disclosure is not limited to this. For example, a privilege may be granted to a user when a predetermined condition is satisfied with respect to power control and when the user uses (or is planning to use) the accommodation facility 300.

The embodiments disclosed herein should be considered to be exemplary and not restrictive in all respects. The scope of the present disclosure is shown by the scope of claims rather than the description of the above embodiments, and is intended to include all modifications within the meaning and the scope equivalent to the scope of claims.

What is claimed is:

1. A power management device that acquires information on a power status of at least one of an accommodation facility and a region in which the accommodation facility is provided, the power management device comprising:
an acquiring unit that obtains the information; and
a control unit that requests a user of an electrified vehicle to perform power control in a power stand based on the information acquired by the acquiring unit, the power control including at least one of external charging and external power supply by using the electrified vehicle, wherein the control unit gives a benefit related to the accommodation facility to the user when a predetermined condition related to the power control is satisfied by the user.

2. The power management device according to claim 1, wherein the control unit gives the benefit to the user when the predetermined condition is satisfied in a power stand provided in the accommodation facility.

3. The power management device according to claim 1, wherein the control unit gives the benefit to the user in at least one of a case in which power is supplied to the accommodation facility by the external power supply and a case in which the power control is performed in response to a power supply and demand adjustment request from a power system in the region.

4. The power management device according to claim 1, wherein the control unit adjusts the benefit in accordance with a contribution degree of the user in the power control.

5. The power management device according to claim 1, wherein giving the benefit includes at least one of the following:
reducing a usage fee of the accommodation facility;
giving at least one of a coupon and a point that is able to be used in at least one of the accommodation facility and a store near the accommodation facility; and
providing a predetermined service in the accommodation facility at less than a normal fee corresponding to the predetermined service.

6. The power management device according to claim 1, wherein the predetermined condition includes that the electrified vehicle is electrically connected to the power stand.

7. A power management system comprising:
a power management device that acquires information of a power state of at least one of an accommodation facility and a region in which the accommodation facility is provided; and
a power stand in which power control including at least one of external charging and external power supply is performed by an electrified vehicle,
wherein the power management device requests a user of the electrified vehicle to perform the power control in the power stand by using the electrified vehicle, based on the information, and gives the user a benefit related to the accommodation facility when a predetermined condition related to the power control is satisfied by the user.
